(19) United States
(12) Patent Application Publication
(10) Pub. No.: US 2008/0162762 A1
(43) Pub. Date: Jul. 3, 2008

(54) INTERRUPT REMAPPING BASED ON REQUESTOR IDENTIFICATION

(76) Inventors: Gilbert Neiger, Portland, OR (US); Rajesh Sankaran Modukkarumukumana, Portland, OR (US); Sridhar Muthrasanallur, Puyallup, WA (US); Sebastian Schoenberg, Hillboro, OR (US); Richard A. Uhlig, Hillsboro, OR (US)

Correspondence Address: INTEL/BLAKELY, 1279 OAKMEAD PARKWAY, SUNNYVALE, CA, 94085-4040, US

(21) Appl. No.: 11/618,456

(22) Filed: Dec. 29, 2006

(51) Int. Cl. G06F 13/24

(52) U.S. Cl. 710/261

(57) ABSTRACT

Embodiments of apparatuses, methods, and systems for interrupt remapping based on requestor identification are disclosed. In one embodiment, an apparatus includes look-up logic, and comparison logic. The look-up logic is to look-up an entry associated with an interrupt request in a data structure. The comparison logic is to compare an identifier of the requestor to a source value in the entry.

### BACKGROUND

1. Field

The present disclosure pertains to the field of information processing, and more particularly, to the field of handling interrupts in an information processing system.

2. Description of Related Art

Generally, the concept of virtualization in information processing systems allows multiple instances of one or more operating systems (each, an “OS”) to run on a single information processing system, even though each OS is designed to have complete, direct control over the system and its resources. Virtualization is typically implemented by using software (e.g., a virtual machine monitor, or a “VMM”) to present to each OS a “virtual machine” (“VM”) having virtual resources, including one or more virtual processors, that the OS may completely and directly control, while the VMM maintains a system environment for implementing virtualization policies such as sharing and/or allocating the physical resources among the VMs (the “virtualization environment”). Each OS, and any other software, that runs on a VM is referred to as a “guest” or as “guest software,” while a “host” or “host software” is software, such as a VMM, that runs outside of the virtualization environment.

A physical processor in an information processing system may support virtualization, for example) by supporting an instruction to enter a virtualization environment to run a guest on a virtual processor (i.e., a physical processor under constraints imposed by a VMM) in a VM. In the virtualization environment, certain events, operations, and situations, such as external interrupts or attempts to access privileged registers or resources, may be intercepted, i.e., cause the processor to exit the virtualization environment so that a VMM may operate, for example, to implement virtualization policies.

Therefore, external interrupts may be intercepted by the VMM and routed to the appropriate virtual processor. However, it may be possible for a guest to use an input/out (“I/O”) device to generate a rogue interrupt. For example, the guest may provide an interrupt service vector, destination identifier, or other attribute that does not correspond to memory or other resources assigned to that guest's VM. Such rogue interrupts may be generated in an attempt to breach system security or otherwise disrupt system activity.

### BRIEF DESCRIPTION OF THE FIGURES

The present invention is illustrated by way of example and not limitation in the accompanying figures.

FIG. 1 illustrates an embodiment of the present invention in an information processing system.

FIG. 2 illustrates an embodiment of the present invention in a chipset.

FIG. 3 illustrates a message signaled interrupt format compatible with an embodiment of the present invention.

FIG. 4 illustrates a message signaled interrupt register format compatible with an embodiment of the present invention

FIG. 5 illustrates an interrupt controller redirection table register format compatible with an embodiment of the present invention.

FIG. 6 illustrates an interrupt remapping table entry according to an embodiment of the present invention.

FIG. 7 illustrates an embodiment of the present invention in a method for remapping interrupts based on requestor identification.

### DETAILED DESCRIPTION

The present invention may be embodied in apparatuses, methods, and systems for remapping interrupts based on requestor identification, as described below. In the description, numerous specific details, such as component and system configurations, may be set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

Embodiments of the present invention may be used to increase the security and/or the performance of an information processing system, for example, by providing for interrupt requests to be routed only to appropriate VMs, by blocking interrupt requests that do not originate from expected sources, and/or by providing the capability to identify, track, and report the source of rogue interrupts. Security may be improved by preventing guests from using rogue interrupts to access memory or other system resources to which they should not have access. Performance may be improved by reducing the number of rogue interrupts and the resulting transfers of control from a guest to a VMM.

Elements of embodiments of the invention may be implemented in hardware, software, firmware, or any combination of hardware, software, or firmware. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, an expression, etc. The term firmware generally refers to a logical structure, a method, a procedure, a program, a routine, a process, an algorithm, a formula, or an expression that is implemented or embodied in a hardware structure (e.g., flash memory or read only memory). Examples of firmware are microcode, writable control store, and micro-programmed structure.

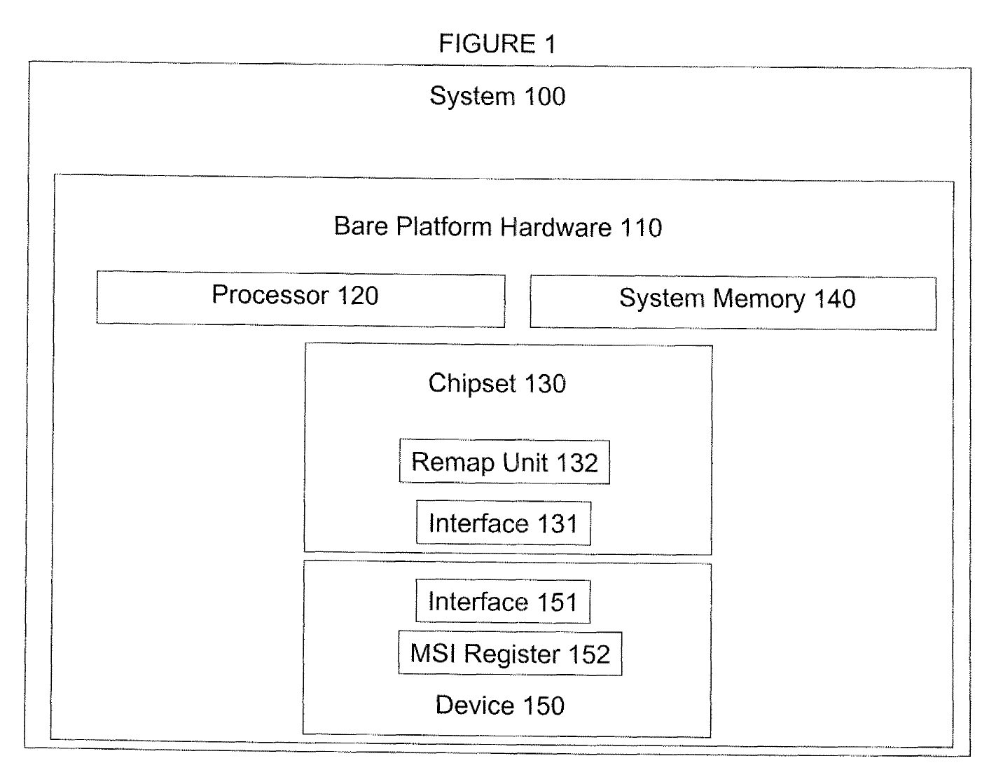

FIG. 1 illustrates an embodiment of the present invention in information processing system 100. Information processing system 100 includes bare platform hardware 110, which may be any apparatus capable of executing any OS, VMM, or other software. For example, bare platform hardware 110 may be the hardware of a personal computer, a mainframe computer, a portable computer, a handheld device, a set-top box, a server, or any other computing system. In this embodiment, bare platform hardware 110 includes processor 120, chipset 130, system memory 140, and device 150.

Processor 120 may be any component having one or more execution cores, where each execution core may be based on any of a variety of different types of processors, including a general purpose microprocessor, such as a processor in the Intel® Pentium® Processor Family, Itanium® Processor Family, or other processor family from Intel® Corporation, or another processor from another company, or a digital signal processor or microcontroller. Although FIG. 1 shows only one such processor 120, bare processing hardware 110 may include any number of processors, including any number of multicore processors, each with any number of execution cores, and any number of multithreaded processors, each with any number of threads.

Chipset 130 may be any group of circuits and logic that supports memory operations, input/output operations, configuration, control, internal or external interface, connection, or communications functions (e.g., “glue” logic and bus bridges), and/or any similar functions for processor 120 and/or system 100. Individual elements of chipset 130 may be grouped together on a single chip, a pair of chips, dispersed among multiple chips, and/or be integrated partially, totally, redundantly, or according to a distributed approach into one or more processors, including processor 120. In this embodiment, chipset 130 includes interrupt remapping unit 132 for remapping interrupts according to an embodiment of the invention, as described below. In other embodiments, interrupt remapping unit 132 may be included elsewhere in system 100.

System memory 140 may be any medium on which information, such as data and/or program code, may be stored, such as static or dynamic random access memory, semiconductor-based read-only or flash memory, magnetic or optical disk memory, or any other type of medium readable by processor 120, or any combination of such mediums.

Device 150 may represent any type of I/O, peripheral, or other device that may be the source of an interrupt request, such as a keyboard, mouse, trackball, pointing device, monitor, printer, media card, network interface, information storage device, etc. Device 150 may be embodied in a discrete component, or may be included in an integrated component with any other devices. In one embodiment, device 150 may represent a function in a multifunctional I/O, peripheral, or other device.

Processor 120, chipset 130, system memory 140, and device 150 may be coupled to or communicate with each other according to any known approach, such as directly or indirectly through one or more parallel, sequential, pipelined, asynchronous, synchronous, wired, wireless, or other bus or point-to-point connection or means of communication. For example, in this embodiment chipset 130 includes interface 131 to receive signals, messages, and/or transactions such as interrupt requests, from device 150, or transmit signals, messages, and/or transactions to device 150 and/or any other agents or components in system 100, through any such connection or other means of communication. Similarly, device 150 includes interface 151 to transmit and/or receive signals, messages, and/or transactions to chipset 130, and/or any other agents or components in system 100. System 100 may also include any number of additional agents, components, or connections.

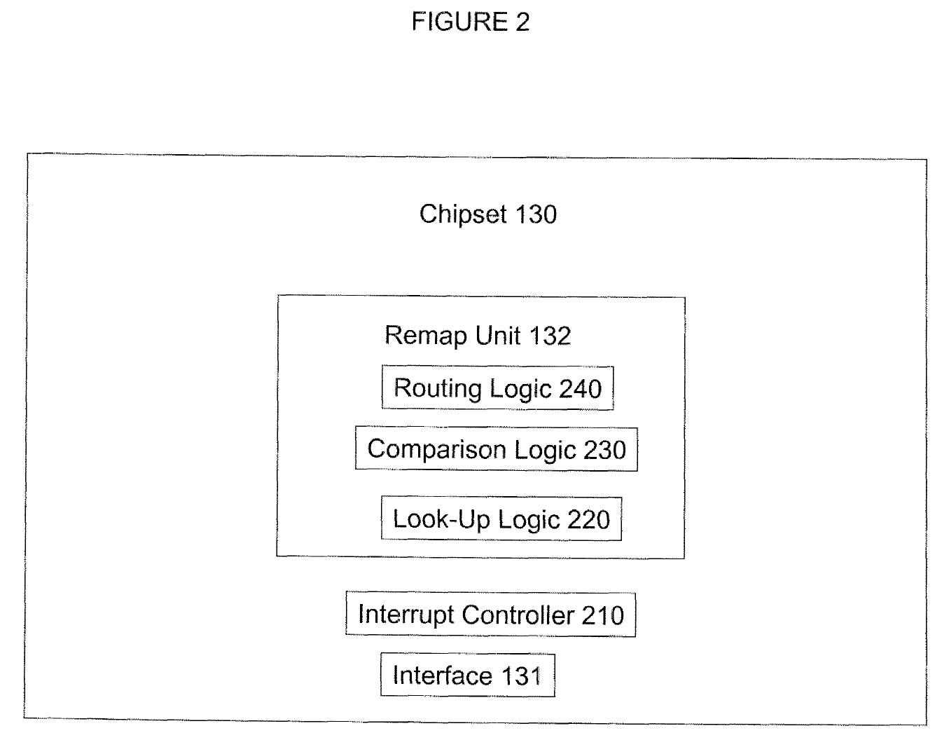

FIG. 2 illustrates chipset 130, including remapping unit 132, according to one embodiment of the present invention. Remapping unit 132 includes look-up logic 220, comparison logic 230, and routing logic 240. Chipset 130 also includes interface 131, described above, and interrupt controller 210.

Chipset 130 may receive an interrupt request through interface 131. An interrupt request may also be generated from within chipset 130, for example where a timer or other device that may generate an interrupt is included in chipset 130. In one embodiment, an interrupt request may be received as a signal, such as a level or edge triggered interrupt signal, according to any known signaling protocol. In another embodiment, an interrupt request may be received as a message, such as a bus message or a point-to-point transaction, according to any known message, transaction, or other communication protocol. In this embodiment, the message may include an identification of the requestor. For example, in an embodiment where device 150 is coupled to chipset 130 through a Peripheral Component Interconnect Express (“PCI-Express”) bus, the transaction header may include a unique identifier of the bus number, device number, and function number (“BDF”) assigned to device 150 by system configuration software or firmware.

In an embodiment where an interrupt request is sent as a signal, the signal may be received by or passed to interrupt controller 210. Interrupt controller 210 may be assigned one or more requester identifiers to be associated with interrupt requests that are received by it, passed to it, generated by it, or are otherwise associated with it. For example, interrupt controller 210 may have any number of input terminals (e.g., 24), each of which may be connected to a device (e.g., through an internal connector to a device within chipset 130, or through an internal connector to an pin or other terminal of chipset 130 to an external connector to a device external to chipset 130) that may generate an interrupt request, and interrupt controller 210 may be assigned the same number (e.g., 24) of unique requester identifiers. In that case, each device connected to an input terminal may be associated with a unique requestor identifier within system 100 by assigning a unique identifier to each input terminal of interrupt controller 210. The assignment may be made by system configuration software or firmware, using one or more programmable registers or other storage locations that may be within or external to interrupt controller 210, or may be hardwired in the hardware, or may be made by any combination of software, firmware, or hardware.

Other embodiments are possible, including an embodiment using both signal and message based interrupt requests. In such an embodiment, an interrupt controller may receive both types of requests; signal based requests through input terminals and message based requests through write transactions to an address or port corresponding to a register or other storage location assigned to the interrupt controller.

Look-up logic 220 is to look up an entry associated with an interrupt request, e.g., from device 150, in a data structure. Look-up logic 220 may be implemented with any logical structure or circuitry that performs a function of looking up or finding an entry in a data structure. The entry may be found using a “handle” as an entry number, address, index, pointer, or other locator of or to a particular entry in the data structure, where the handle is a value supplied directly or indirectly by the interrupt request.

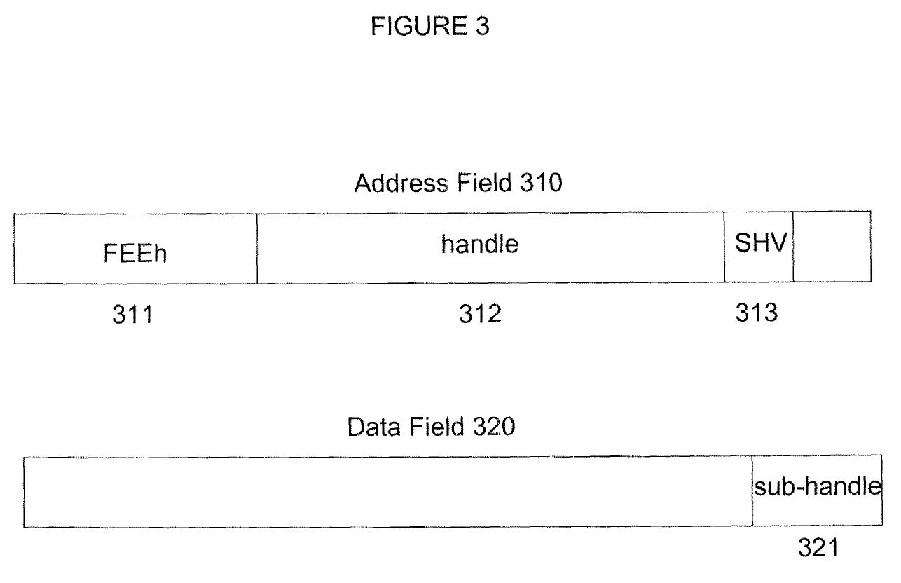

For example, according to a message signaled interrupt (“MSI”) protocol of a PCI-Express bus, an interrupt message may include a 32-bit address field and a 32-bit data field, where bits 31:20 of the address field are set to the hexadecimal value “FEE” to indicate that the message is an interrupt request. The remaining bits of the fields may be used to indicate other information, such as the interrupt vector and the desired destination for the interrupt request. An embodiment of the present invention compatible with this protocol may use the formats shown in FIG. 3.

In FIG. 3, 32-bit address field 310 includes bit-fields 311, 312, and 313, and 32-bit data field 320 includes bit-field 321. Bit-field 311 may include bits 31:20 of address field 310, and may be set to the hexadecimal value “FEE” to indicate that the message is an interrupt request. Bit-field 312 may include bits 19:4 of address field 310, and may be used to indicate a 16-bit handle value. Bit-field 313 may include bit 3 of address field 310, and may be used to indicate a 1-bit sub-handle valid (“SHV”) value. Bit-field 321 may include bits 4:0 of data field 320, and may be used to indicate a 5-bit sub-handle value. The use of the SHV and sub-handle values will be described below. The remaining bits of address field 310 and data field 320 may be treated as reserved or ignored.

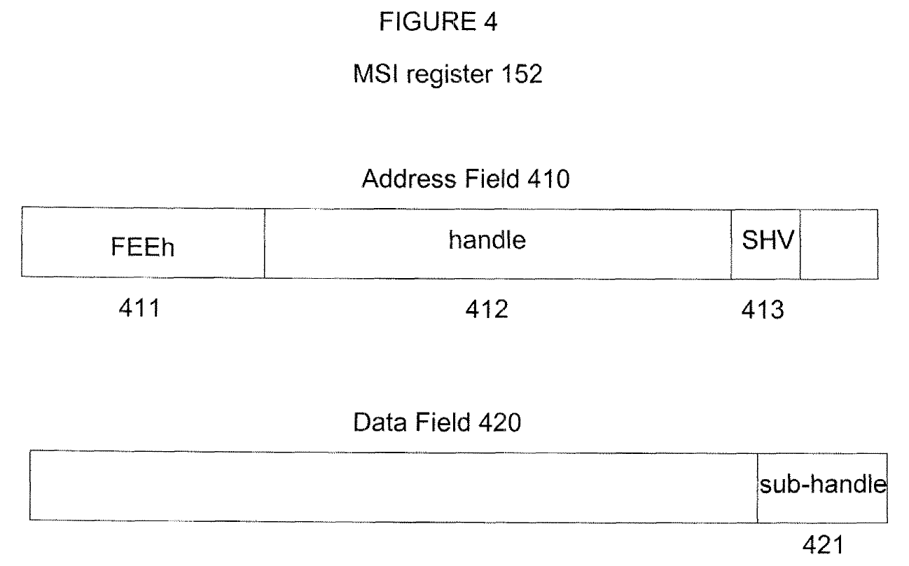

In order to generate an MSI transaction in such a format, device 150, or any other device in system 100, including a device integrated into chipset 130, may include a register or other storage location such as MSI register 152, as shown in FIG. 4. MSI register 152 may include 32-bit address field 410 and 32-bit data field 420. Address field 410 includes bit-fields 411, 412, and 413, and data field 420 includes bit-field 421. Bit-field 411 may include bits 31:20 of address field 410, and may be set to the hexadecimal value “FEE” to indicate that the message is an interrupt request. Bit-field 412 may include bits 19:4 of address field 410, and may be used to indicate a 16-bit handle value. Bit-field 413 may include bit 3 of address field 410, and may be used to indicate a 1-bit sub-handle valid (“SHV”) value. Bit-field 421 may include bits 4:0 of data field 420, and may be used to indicate a 5-bit sub-handle value. The use of the SHV and sub-handle values will be described below. The remaining bits of address field 410 and data field 420 may be treated as reserved or ignored.

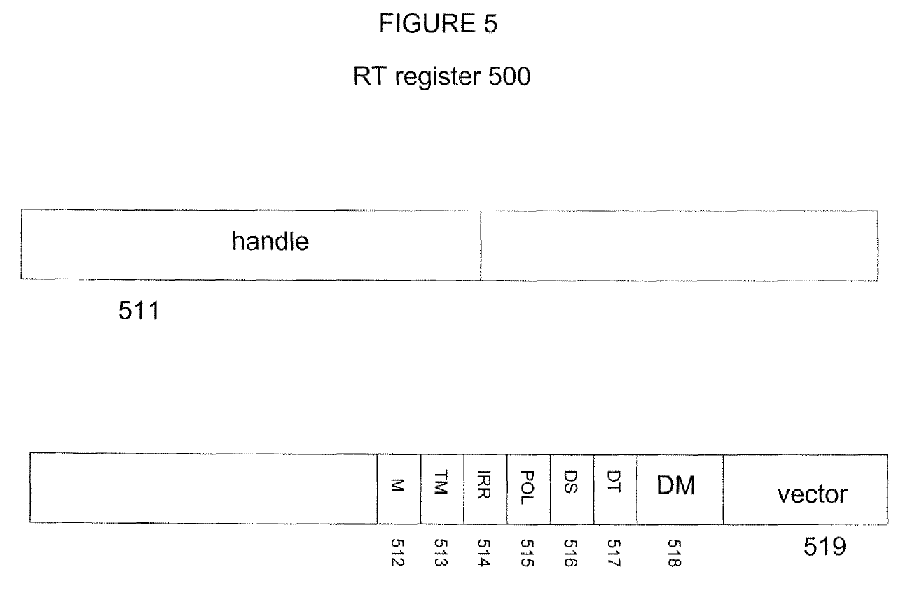

Similarly, in an embodiment using where interrupt controller 210 is an I/O Advanced Programmable Interrupt Controller (“IO APIC”) according to the architecture of the Intel® Pentium® Processor Family, the redirection table (“RT”) register of the IO APIC may be programmed as shown in FIG. 5 in order to generate interrupts that are compatible with an embodiment of the invention. In FIG. 5, RT entry 500 includes bit-fields 511, 512, 513, 514, 515, 516, 517, 518, and 519. Bit-field 511 includes bits 63:48 of RT entry 500, to indicate a 16-bit handle value. Bit-fields 512, 513, 514, 515, 516, and 517 include bits 16, 15, 14, 13, 12, and 11, respectively, of RT entry 500, to indicate mask, trigger mode, remote interrupt request register, interrupt input pin polarity, delivery status, and destination mode values, respectively, and provide the functionality of the known programming model. Bit-field 518 includes bits 10:8 of RT entry 500, to be set to logical ‘000’ or ‘111’ to indicate that the deliver mode is fixed or external, respectively. Bit-field 519 includes bits 7:0 of RT entry 500, to indicate an 8-bit interrupt vector.

Returning to look-up logic 220 of FIG. 2, in one embodiment look-up logic 220 may use a 16-bit handle from an MSI transaction, a 16-bit handle from an 10 APIC to find an entry in a single level interrupt remapping table (“IRT”) having 64K entries (each an “IRTE”). In another embodiment, where an MSI transaction includes an SHM that is set to a logical ‘1’, or otherwise indicates that it includes a valid sub-handle, a 5-bit sub-handle from the transaction may be applied (e.g., logically or arithmetically combined with, as a mask or offset value) to a 16-bit handle from the transaction to form a 16-bit effective handle, and the effective handle may be used by look-up logic 220 to find an IRTE. The value of the effective handle may be checked to ensure that it is directing look-up logic 220 to a location within the IRT. Other embodiments may use different sizes of handles, sub-handles, effective handles, and IRTs.

An IRT, or any other data structure to which look-up logic 220 refers, may be stored in system memory 140, or in any other storage area in system 100. In some embodiments, IRTEs may be cached in a storage area in remapping unit 132 or in any other area that is temporally or physically nearer to look-up logic 220 than the IRT.

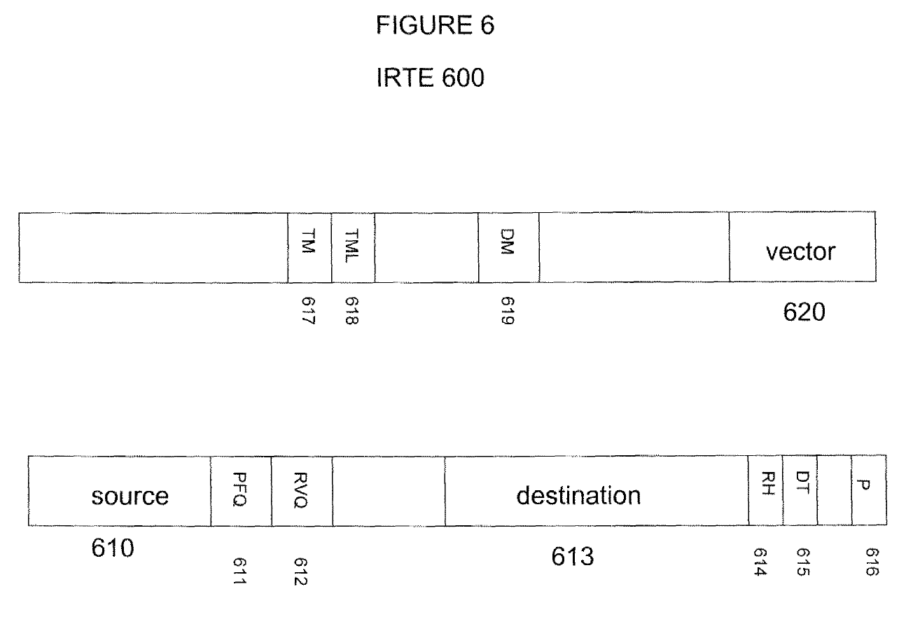

In one embodiment, each IRTE may have the format shown in FIG. 6. In FIG. 6, IRTE 600 includes bit-fields 610, 611, 612, 613, 614, 615, 616, 617, 618, 619, and 620. Bit-field 610 may include bits 63:48 to indicate a 16-bit source value or source identifier. Bit-field 611 may include bits 47:46 to indicate a 2-bit phantom function qualifier (“PFQ”) as described below. Bit-field 612 may include bits 45:44 to indicate a 2-bit requester identifier validation qualifier (“RVQ”), as described below. Bit-field 613 may include bits 35:4 to indicate a 32-bit destination value or destination identifier. Bit-field 616 may include bit 0 to indicate whether the IRTE is present (“P”), as described below. Bit-fields 614, 615, 617, 618, and 619 may include bits 3, 2, 87, 86, and 82:80, respectively, to indicate a redirection hint, a destination mode, a trigger mode, a trigger mode level, and a delivery mode, respectively, each an attribute of interrupt requests according to the MSS and/or IO APIC programming models, to be used for interrupt requests that are forwarded according to the present invention. Bit-field 620 may include bits 71:64 to indicate an S-bit interrupt vector.

Returning to FIG. 2, comparison logic 230 is to compare an identifier of the requestor to a source value in the entry. Routing logic 240 is to forward the interrupt request to a destination corresponding to a destination value in the entry, in response to comparison logic 230 determining that the requestor identifier matches the source value. Routing logic 240 is also to block the interrupt request in response to comparison logic 230 determining that there is a mismatch between the requestor identifier and the source value. Routing logic 240 may also block the interrupt request based on other criteria. For example, routing logic 240 may block the interrupt request if the value of the P bit in the IRTE is a logical zero.

Comparison logic 230 may be implemented with any logical structure or circuitry that performs a function of logically or arithmetically comparing two values or any number of bit locations from two values. In this embodiment, comparison logic 230 may be configured to make different comparisons, depending on the value found in the RVQ field of the IRTE. If ‘00’ is stored in the RVQ field, no comparison is made. If ‘01’ or ‘10’ is stored in the RVQ, a comparison is made based on two 16-bit values. One of the 16-bit values, where one of the 16-bit values is the requestor identifier associated with the interrupt request that provided the handle to find the IRTE, and the other 16-bit value is the source identifier from the IRTE.

More specifically, in this embodiment, the requestor identifier may be represented as a 16-bit BDF number, including an 8-bit bus number, a 5-bit device number, and a 3-bit function number. The 16-bit source identifier field may be arranged in the format of a 16-bit BDF, or may be arranged as two 8-bit bus numbers. If ‘10’ is stored in the RVQ field, then comparison logic 230 is used to verify that the 8-bit bus number from the requestor identifier is in the range between the 8-bit bus number identified by the upper half of the source identifier field and the 8-bit bus number identified by the lower half of the source identifier field, or is equal to either of them. If ‘01’ is stored in the RVQ field, then all or a portion of the 16-bit requester identifier, in BDF format, is compared to a corresponding portion of the 16-bit source identifier, also in BDE format. The portion that is compared depends on the value of the PFQ field in the IRTE. If ‘00’ is stored in the PFQ field, then all 16 bits are compared. If ‘01’ is stored in the PFQ field, then all bits except the most significant bit of the function number are compared. If ‘10’ is stored in the PFQ field, then all bits except the two most significant bits of the function number are compared. If ‘11’ is stored in the PFQ field, then all bits except the three bits of the function number are compared.

In other embodiments, other types of comparisons are possible. In any of the embodiments, a comparison may be considered to result in a match if a prescribed condition is met, e.g., the bus number from the requestor identifier is between two bus numbers from the source identifier field, even if the compared values are not identical.

A result of the comparison by comparison logic 230, or other criteria related to the performance of the comparison, may be used by routing logic 240 to determine whether to forward or block the interrupt request. In this embodiment, routing logic 240 forwards the interrupt request if the comparison results in a match, or if the IRTE is present (i.e., P is ‘1’) but no comparison is performed (i.e., RVQ is ‘00’), and routing logic 240 blocks the interrupt request if the comparison results in a mismatch, or if the IRTE is not present (i.e., P is ‘0’).

In this embodiment, if the interrupt request is forwarded, it is forwarded to the destination identified by the destination identified by the destination value in the IRTE, which may be a processor or processors, a local interrupt controller associated with a processor or processors, or any other potential destination for interrupt requests in system 100. The interrupt is forwarded with or according to the attributes specified by the IRTE.

Therefore, a VMM, OS, or other such software running on bare platform hardware 110 may use embodiments of the present invention to block or censor interrupt requests from devices within system 100, and/or to control the attributes of remapped or forwarded interrupt requests. The blocking of interrupt requests by remapping unit 132 may be reported to such software, which may record and monitor the corresponding interrupt request activity and related information, including the identity of the requesting device. Then, the software and/or a user of the system may take action to protect the security or preserve the performance of the system, such as to shut down the software responsible for the device generating rogue interrupts.

Embodiments of the invention also provide for a VMM or other such software to reprogram an IRTE to update the attributes of an interrupt request without reprogramming interrupt controller or MSI registers. For example, a VMM may change the destination of an interrupt request to support dynamically migrating a guest from one core, domain, or other physical or virtual resource to another, for load balancing or any other purpose.

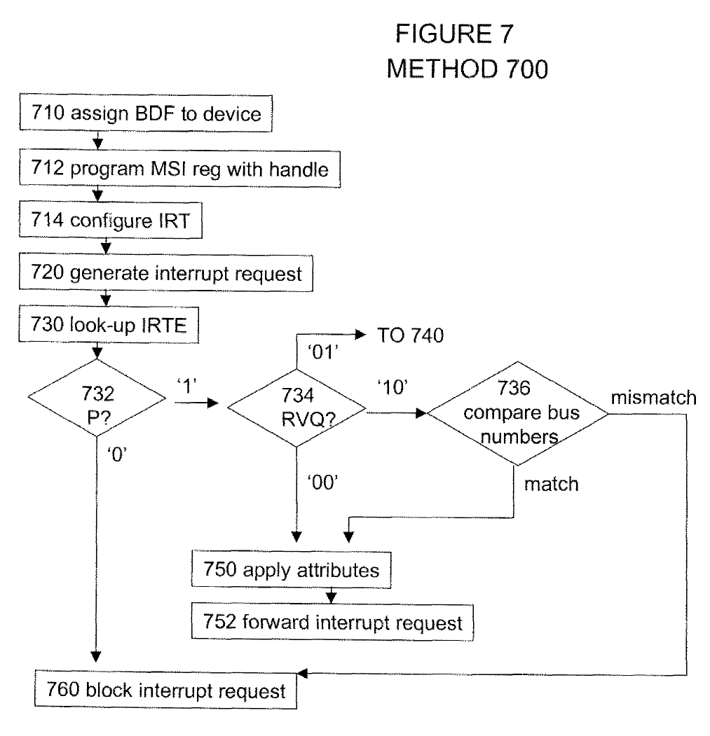

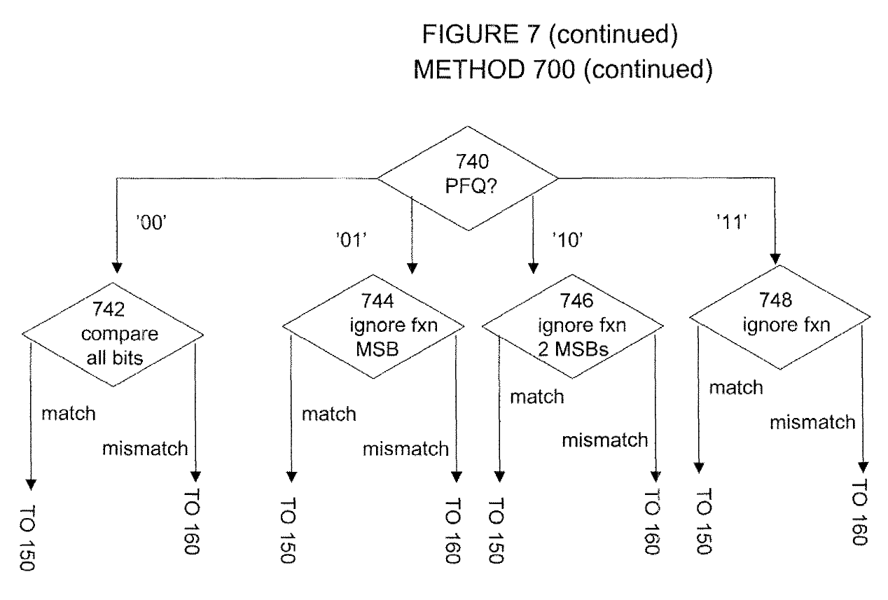

FIG. 7 illustrates an embodiment of the present invention in method 700, a method for remapping interrupts based on requestor identification. Although method embodiments are not limited in this respect, reference is made to the description of system 100 of FIG. 1 to describe the method embodiment of FIG. 7.

In box 710 of FIG. 7, an information processing system, e.g., system 100, is configured such that each device, or function within a device, e.g., device 150, is assigned a BDF. In box 712, the device is programmed to generate interrupt requests including a handle. In box 714, an interrupt remapping data structure, e.g., an IRT as described above, is configured with one or more entries, e.g., IRTEs as described above. In box 720, an interrupt request, including the handle, is sent from the device to an interrupt remapping unit, e.g., remapping unit 132.

In box 730, look-up logic 230 uses the handle from the interrupt request to find an IRTE. In box 732, the value of the P bit in the IRTE is determined. If the P bit is clear, method 700 continues at box 760. If the P bit is set, method 700 continues at box 734. In box 734, the value of the RVQ field is determined. If the value is ‘00’ method 700 continues at box 750. If the value is ‘10’ method 700 continues at box 736. If the value is ‘01’ method 700 continues at box 740.

In box 736, the bus number from the requestor identifier is compared to the source bus numbers from the upper and lower halves of the source field of the IRTE. If the bus number from the requester identifier is between the source bus numbers, or equal to either of them, then method 700 continues at box 750. If not, method 700 continues at box 760.

At box 740, the value of the PFQ field is determined. If the value is ‘00’ method 700 continues at box 742. If the value is ‘01’ method 700 continues at box 744. If the value is ‘10’ method 700 continues at box 746. If the value is ‘11’ method 700 continues at box 748. In box 742, all bits of the requestor identifier are compared to the source value. In box 744, all bits of the requestor identifier except the most significant bit of the function number are compared to the source value. In box 746, all bits of the requestor identifier except the two most significant bits of the function number are compared to the source value. In box 748, all bits of the requestor identifier except the three bits of the function number are compared to the source value. From each of boxes 742, 744, 746, and 748, on a match, flow continues at box 750, while on a mismatch, flow continues at box 760.

In box 750, the attributes specified by the IRTE are applied to, attached to, or otherwise associated with the interrupt request. In box 752, the interrupt request is forwarded to the destination specified by the IRTE.

In box 760, the interrupt request is blocked.

Within the scope of the present invention, method 700 may be performed with illustrated boxes omitted, with additional boxes added, or with a combination of reordered, omitted, or additional boxes.

Any component or portion of a component designed according to an embodiment of the present invention may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these media may “carry” or “indicate” the design, or other information used in an embodiment of the present invention. When an electrical carrier wave indicating or carrying the information is transmitted, to the extent that copying, buffering, or re-transmission of the electrical signal is performed, a new copy is made. Thus, the actions of a communication provider or a network provider may constitute the making of copies of an article, e.g., a carrier wave, embodying techniques of the present invention.

Thus, apparatuses, methods, and systems for remapping an interrupt based on requestor identification have been disclosed. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
lookup logic to look up an entry associated with an interrupt request in a data structure; and
comparison logic to compare an identifier of the requester of the interrupt to a source value in the entry.

2. The apparatus of claim 1, further comprising routing logic to forward the interrupt request, in response to a match from the comparison logic.

3. The apparatus of claim 1, further comprising routing logic to forward the interrupt request to a destination corresponding to a destination value in the entry, in response to a match from the comparison logic.

4. The apparatus of claim 1, wherein the routing logic is also to block the interrupt request, in response to a mismatch from the comparison logic.

5. The apparatus of claim 1, wherein the look-up logic is to use a handle from the interrupt request to look up the entry.

6. The apparatus of claim 1, wherein the look-up logic is to use a handle from an interrupt controller to look up the entry.

7. The apparatus of claim 1, wherein the compawison logic is to compare a bus number of the requestor to a bus number from the source value.

8. The apparatus of claim 7, wherein the comparison logic is also to compare a device number of the requestor to a device number from the source value.

9. The apparatus of claim 8, wherein the comparison logic is also to compare a function number of the requester to a function number from the source value.

10. The apparatus of claim 1, wherein the comparison logic is configurable based on a requester validation qualifier from the entry.

11. A method comprising:
entering a source value in an interrupt remapping data structure; and
comparing a requester identifier associated with an interrupt request with the source value.

12. The method of claim 11, further comprising using a handle from the interrupt request to find the entry containing the source value.

13. The method of claim 11, further comprising forwarding the interrupt request to a destination if the result of the comparing is a match.

14. The method of claim 11, further comprising blocking the interrupt request if the result of the comparing is a mismatch.

15. The method of claim 11, wherein comparing includes comparing a bus number of the requestor with a bus number from the source value.

16. The method of claim 15, wherein comparing also includes comparing a device number of the requestor with a device number from the source value.

17. The method of claim 11, further comprising configuring comparison logic to make the comparison based on a requestor validation qualifier in the entry containing the source value.

18. A system comprising
a device to request an interrupt; and
an interrupt remapping unit including,
look-up logic to look up an entry associated with an interrupt request in a data structure; and
comparison logic to compare an identifier of the device to a source value in the entry.

19. The system of claim 18, further comprising a destination, wherein the interrupt remapping unit also includes routing logic to forward the interrupt request to the destination in response to a match from the comparison logic.

20. The system of claim 19, wherein the interrupt remapping unit also includes routing logic to block the interrupt request in response to a mismatch from the comparison logic.
